(19) United States
(12) Patent Application Publication
(10) Pub. No.: US 2004/0159494 A1
(43) Pub. Date: Aug. 19, 2004

(54) Automatic personnel lowering system for high-rise buildings

(76) Inventor: Ataul Haq, Alexandria, VA (US)

Correspondence Address: ATAUL HAQ, 5340 HOLMES RUN PKWY # 1412, ALEXANDRIA, VA, 22304, US

(21) Appl. No.: 10/777,729

(22) Filed: Feb. 13, 2004

Related U.S. Application Data
(60) Provisional application No. 60/447,278, filed on Feb. 14, 2003.

(51) Int. Cl. A62B 1/10

(52) U.S. Cl. 182/239; 182/238

(57) ABSTRACT

An automatic cable delivery system that can lower heavy weights from some heights with automatically controlled deceleration. This device is capable of sensing the amount of the load being lowered and therefore automatically adjust the resistance on a continuous basis thereby controls the descending speed to a desirable rate regardless of the weight. This automatic descending system is very useful during evacuation in case of emergency from high-rise building and similar structures. This unit is very portable and does not require any permanent fixture. This unit consists of a translucent clutch, hydraulic or mechanical, in conjunction with a unidirectional retractable cable spool coupled trough a planetary gear system. This unit is fitted with a retractor, which retracts the cable once it is released. This retraction is faster than the controlled release of the cable during lowering of load.

### CROSS REFERENCE TO THE RELATED APPLICATION

This application claims the benefit of U.S Provisional Patent Application Serial No. 60/447,278, filed Feb. 14, 2003.

### BACKGROUND OF THE INVENTION

This present invention relates to an automatic personnel-descending system to use in case of emergency jump-out situation from a high-rise building. The system is fully integrated and automatic, which is capable of sensing weight and adjust the descend speed accordingly, thereby providing same lowering speed regardless of the weight. The system is very portable and can be used for different purpose and can be set or tied to any strong furniture, fixture or otherwise attached to the weight using strap arrangement.

Several prior arts been examined, such as, Chiu el, at. U.S. Pat. No. 5,884,726, Mar. 23, 1999, Tien U.S. Pat. No. 5,842,542 Dec. 1, 1998, Mai U.S. Pat. No. 5,590,740 Jan. 7, 1997 and Ishioka U.S. Pat. No. 5,060,758 Oct. 29, 1991. These inventions have addressed the issue and have attempted to invent a system in order to address the emergency evacuation. However, none of this invention is close to the present invention in the form of functionality, design, performance or concept.

### SUMMARY OF THE INVENTION

This automatic descending system for emergency evacuation from high-rise building is suitable for lowering human being from an adult to a child. This automatic system delivers the lowering load to a speed, which is automatically adjusted on continuous basis depending on the load. This rugged system is very portable and extremely handy. The cable retracts back to the elevation with a faster speed thereby help other person to follow down at a minimum time. The descending operation is controlled and very safe, due to this feature the impact with the ground is nominal. The operation of this unit is so simple that a kid can descend from a high-rise building in case of emergency in minutes.

### BRIEF DESCRIPTION OF THE DRAWING

FIG. 1 explains across section of the art showing components and component assemblies.

1. Casing

2. Coil Spring

3. Ball Bearings

4. Cable Spool

5. Cable

6. Primary Shaft

7. Intermediate Shaft

8. Clutch Shaft

9. Flywheel Gear

10. Set of Planetary Gears

11. Speed pinion

12. Unidirectional Clutch/Ratchet

13. Expandable clutch vanes/governors

14. Planetary arm

15. Fixed vanes hydraulic clutch

16. Translucent clutch assembly

17. Tie down assembly

18. Hydraulic fluid for clutch

19. Fluid maintenance plug

20. Compression spring

21. Guide roller for cable

22. Hydraulic seals.

### DETAILED DESCRIPTION OF PREFFERED EMBODIMENTS

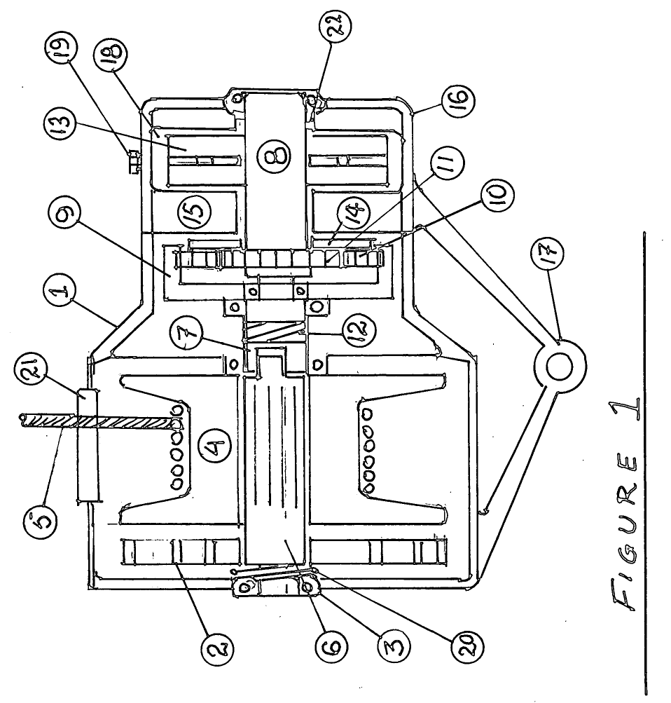

1. The present invention is a break through in safety devices for high-rise buildings for safety of lives in case of emergency evacuation. FIG. 1 describes a portable unit, which can be attached to several different fixtures or a heavy piece of furniture in case of emergency. In some cases it can also be tied to the load itself In a typical emergency situation this unit is tied down to any available stable furniture or fixture at the tie-down point (17).

2. This integrated portable descending system comprises of, but not limited to, a retractable cable (5), made of nylon, fiber or similar material, wound on a spool (4) enclosed in a casing (1). This spool (4) is arranged on a limited floating shaft (6) along with a compression spring (20) on one side and a unidirectional ratchet clutch or similar clutch (12) on the other side. The shaft (6) is attached to a long coil spring (2) for providing fast retraction of the cable once it is released. The shafts are fitted with ball bearings (3) for minimum friction. The cable is delivered over a guide roller (21).

3. This automatic descending system as described in FIG. 1 is integrated with a clutch (16), hydraulic or mechanical, the coupling of the cable spool (4) and the translucent clutch (16) is through a ratcheting clutch (12) attached to a intermediate shaft (7) which floats over the clutch shaft (8). All the shafts are supported with ball bearings (3) and seals (22). This unidirectional coupling or clutch (12) engages the translucent clutch (16) only during the pull out of cable. During this controlled pull out, the other side wounds a long coil spring (2) over the shaft. As the cable is released the spool disengages itself from the clutch (12) therefore allowing the cable to retract faster.

4. This automatic controlled lowering system can be very useful safety device for emergency jump out from the high-rise buildings in case of fire or other hazard. The load sensing hydraulic opr mechanical clutch (16) is coupled via a set of planetary gears (10) set under a flywheel gear (9) arranged in a manner over a pinion gear (11) attached via planetary arm (14) in order to provide increase rotation to the clutch shaft (8). The clutch is fitted with expandable vanes (13) or load governors in conjunction with fixed vanes (15) in order to provide increased resistance with increased load. In case of a hydraulic clutch, the clutch is provided with hydraulic fluid (18) and fluid maintenance plug (19).

I claim:

1. An automatic portable lowering system consisting of, but limited to, a integrated casing, retractable coil spring, ball bearings, hydraulic seals, cable spool, lowering cable, shafts, planetary gear system, flywheel gear, unidirectional clutch, translucent clutch, tie down hook or arrangement, cable guide roller, compression spring, fabricated and integrated in a manner to make a solid portable automatic descending system for lowering of weights or human from high-rise buildings in a safe manner along with speed retraction of cable at the release of cable for next use.

2. The integrated hydraulic or mechanical clutch, as per claim # 1, which consists of, but not limited to, fixed vanes or friction plates, expandable vanes or mechanical governors, hydraulic fluid, seals, bearings, planetary gear system and shaft, fabricated, integrated and assembled in a manner to form a translucent clutch capable of providing increased friction on continuous basis to the cable spool shaft in a manner to oppose the load on the cable to a desired level, thereby help lower the load without a serious impact on the ground.

3. The integrated cable and spool system, as per claim # 1, which consists of, but not limited to, delivery cable, guide roller, bearings, floating shaft, spring, cable spool, retracting coil spring, fabricated and assembled in a manner to form an integrated cable delivery and fast cable retracting mechanism completely coupled with hydraulic clutch via a unidirectional clutch or ratchet mechanism.

4. The planetary gear mechanism, as per claim # 1, consisting of but not limited to, flywheel gear, planetary gears, pinion gear, floating shaft, bearings, seals, unidirectional clutch mechanism, clutch coupling, springs fabricated and assembled in a manner to form an integrated high revolution system to provide high spin to the integrated clutch assembly for the purpose of increased drag in order to offset the load on the cable or cable spool.

5. The integrated hook or tie down arrangement, as per claim # 1, comprises of but not limited to, reinforced hook or eye extension, belt or strap arrangement integrated and fabricated in a manner to provide a strong and secure method of tie down of the automatic descending system for the purpose of lowering of personnel or load from the high elevation.
